(19) United States
(12) Patent Application Publication
(10) Pub. No.: US 2004/0203867 A1
(43) Pub. Date: Oct. 14, 2004

(54) Localization of a mobile end user unit by monitoring a geographical area

(76) Inventor: Karst Schmidt, Potsdam (DE)

Correspondence Address: Karsten Schmidt, Lennestrasse 76, Potsdam, D-14471, DE

(21) Appl. No.: 10/209,429

(22) Filed: Jul. 30, 2002

(51) Int. Cl. H04Q 7/20; H04M 1/00; H04B 1/38

(52) U.S. Cl. 455/456.1; 455/457; 455/557

(57) ABSTRACT

A method for localization of a mobile end user unit by monitoring a geographical area utilizing a cellular communications environment, comprising steps of, defining a geographical monitoring area, the geographical monitoring area being a geographical area to be monitored, mapping the geographical monitoring area to at least one cell of the cellular communications environment such that a geographical area corresponding to the at least one cell of the cellular communication environment comprises the geographical monitoring area, identifying at least one cell of the cellular communications environment wherein the mobile end user unit is active, comparing the at least one cell wherein the mobile end user unit is active and the at least one cell the geographical monitoring is mapped to, and monitoring the geographical monitoring area on the basis of a result of the comparing step in order to localize the mobile end user unit.

### FIELD OF THE INVENTION

In general, the present invention relates to cellular communications environments. In particular, the present invention relates to the utilization of a cellular communications environment and an end user unit that is adapted for mobile communications for monitoring a geographical area and related methods, units, devices, communications environments, software program products and services.

### BACKGROUND OF THE INVENTION

In view of increasing security demands, numerous approaches for surveillance of persons and mobile and moveable objects have been proposed. A traditional directional radio based localization has been virtually completely replaced by satellite-based technologies or approaches utilizing communications environments for mobile communications.

Examples of satellite-based localization approaches include localization systems using the global positioning system (GPS). The global positioning system includes orbiting satellites emitting signals. The signals from the satellites are received by GPS capable receivers which calculate their respective geographical locations on the basis of received satellite signals. GPS-based location requires specific receivers especially adapted for receiving GPS satellite signals. Usually, GPS receivers are stand-alone units or integrated, for example, in a car stereo system. With these systems, a person using a GPS receiver can determine their geographical location based on the geographical location of the utilized GPS receiver.

In order to determine a geographical location of a person or an object (e.g. car, plane, ship) from a remote location, it is necessary to provide GPS receivers that transmit their current location to receivers at the remote location. For the transmission of geographical localization data of such a GPS receiver, radio signaling and, recently, mobile communications, for example, in a mobile telephone network, are used. Accordingly, such a GPS based-localization system implements different technologies, namely a global positioning system and a system to transmit geographical location data from GPS receivers. As a result, such arrangements are complex and expensive and, in most cases, are not user-friendly due to required hardware and software components.

A further disadvantage of GPS-based location systems is the high energy consumption of GPS receivers resulting in short operating periods especially for portable GPS receivers. Moreover, GPS receivers necessarily have large dimensions, thereby making it difficult to carry a GPS receiver. A further problem with GPS-based localization system is that GPS-based positioning is typically not available within buildings or closed environments where GPS satellite signals cannot be received.

In spite of the problems associated with GPS-based localization, increasing security demands to protect persons and especially children have resulted in GPS-based localization systems for controlling the location of a person. With such arrangements, specifically adapted GPS receivers are employed which transmit warning or alarm information indicative that a person carrying such a GPS receiver has left a predefined geographical area. The warning or alarm information is transmitted via a mobile telephone network. For warning or alarm information transmission, such a GPS receiver has to establish a telephone connection within a mobile telephone network to a predefined destination, for example a telephone at the premises of parents of a child. To determine if a person carrying such GPS receiver has left a predefined geographical area, the GPS receiver compares its current geographical location calculated from GPS satellite signals with data stored therein being indicative of the predefined geographical area. As set forth above, such localization systems do not effectively operate within closed environments such as buildings and have a limited operation time because of their high power consumption requirements.

Increasingly, localization systems are proposed which use existing cellular telephone network infrastructure. While GPS is a system especially implemented for localization purposes, cellular telephone environments as such do not provide for the localization of person and objects. Therefore, modifications of cellular telephone environments are necessary. All approaches for localization techniques utilizing cellular telephone environments necessitate information concerning the geographical arrangement of cells of a telephone environment. Traditionally, such information has only been available to providers and operators of cellular telephone environments thereby restricting implementation of localization techniques to third parties.

In contrast to GPS-based localization which provides a locational resolution of up to a few meters, cellular telephone environment-based localization provides locational resolution in a range of 50 to 300 m. Advantages of approaches utilizing cellular telephone environments are significantly lower power consumption compared to GPS-based approaches, operability within closed environments (e.g. buildings) and the ability to employ commercial mobile telephones.

With localization methods based on the use of mobile telephones, the location of a mobile telephone is determined by evaluating signals communicated between the mobile telephone and radio base stations of a cellular telephone network. This signal evaluation between mobile telephones and radio base stations requires a triangulation with respect to signals received from several radio basis stations, measurements of signal transmission times for signals exchanged between mobile telephones and radio base stations, measurements of orientations and propagations of signals emitted by a mobile telephone with respect to the radio base stations and determinations of parameters including directional information with respect to the spatial arrangement of mobile telephones and radio base stations.

A mobile telephone based localization system has been implemented in the United States in response to the requirement for telephone network providers and manufactures of mobile telephones to ensure that a location of a mobile telephone from which an emergency call (“911”) is placed can be determined within a range of 125 m.

U.S. Pat. No. 5,722,083 describes a method for determining a localization of a mobile radio terminal within a space division multiple excess mobile radio system by evaluating directional and/or distance information assigned to a base division multiple excess radio link between the mobile radio terminal and at least one base station. The location of the mobile radio terminal is compared with a location of a destination selected by the user of the mobile radio terminal, for example, a museum or a church. On the basis of such a comparison, the user of the mobile radio terminal is provided information to reach the desired destination.

U.S. Pat. No. 6,275,705 B1 discloses a location and tracking system where the location of a mobile-radio frequency transceiver is determined on the basis of relative time offsets for signal transmissions between the mobile radio frequency transceiver and the base station.

U.S. Pat. No. 5,844,522 discloses a portable phone tracking system which utilizes components of an existing wireless telephone communication systems such as a cellular telephone network. Each cell site of a cellular telephone network is provided with an agile vector sensor unit for detecting angle and strength information with respect to signals communicated between a mobile telephone and a radio base station in a network cell.

U.S. Pat. No. 6,243,574 B1 discloses a mobile telephone distribution system having programming and tracking. This system is intended as a cellular telephone accounting system where the tracking of mobile telephones is used to determine in which telephone network a mobile telephone is operated and which provider services the mobile telephone. On the basis of such information, it is possible to associate costs related to the use of a mobile telephone to its user and used networks and providers. For a localization of a mobile telephone, the electronic serial number (ESN) of the mobile telephone and information that indicates in which telephone network or network cell the mobile telephone is operated are used.

A common problem for all localization systems and methods utilizing components of an existing cellular telephone environment is that for the determination of a location of a mobile telephone, the infrastructure of the cellular telephone environment or at least parts thereof (cells) is loaded. This loading is mainly due to the specific signal transmissions that are often performed at high rates over short time intervals. Further, many conventional mobile telephone-based localization systems and methods require modifications of mobile telephones to be localized and the infrastructure of an employed cellular telephone network. Examples include mobile telephones emitting a specific localization signals and radio base stations including specific units for localization purposes. Moreover, any implementation of a mobile telephone-based localization is in general limited to network and/or service providers of a cellular telephone environment as information and infrastructure modifications for localization purposes are not available to third parties.

### OBJECT OF THE INVENTION

In general, the object of the present invention is to overcome the above problems of known approaches for the localization of mobile end user devices associated to a person or an object. In particular, the object of the present invention is to provide solutions for the localization of mobile end user units for a cellular communications environment which can be performed with minor or no additional load for the communications environment infrastructure, is user friendly and easily adapted to different applications. Moreover, such solutions should permit the localization of a mobile end user unit independently from a network or service of a cellular communications environment.

### SUMMARY OF THE INVENTION

The above object is achieved by a method for localization of a mobile end user unit by monitoring a geographical area utilizing a cellular communications environment. Examples for possible cellular communication environment are cellular telephone network such as GSM and UTMS telephone networks. Examples for mobile end user units comprise mobile telephones such as GSM telephones and UTMS telephones, mobile computing devices and units having communications capabilities in cellular communications environment and the like.

According to the present invention the monitoring method comprises defining a geographical monitoring area wherein the geographical monitoring area is that geographical area which is desired to be monitored. The geographical monitoring area is mapped to at least one cell of the cellular communications environment in a manner such that a geographical area covered by the at least one cell comprises the geographical monitoring area. Preferably, the mapping is performed such that only cells are included which comprise at least a part of the geographical monitoring area.

Then, it is determined or identified for all cells of the cellular communications environment in which of these cells the mobile end user unit is active. Active as used herein refers to an operation of the mobile end user unit not necessarily including actual communications. Rather, an active mobile end user unit can just be turned on so that it only communicates fundamental signaling within the cellular communications environment. The at least one cell wherein the active mobile end user unit is detected (the at least one identified cell) and the at least one cell to which the geographically monitoring unit is mapped (the at least one mapped cell) are compared. On the basis of a result of this comparison, the geographical monitoring area is monitored so as to localize the mobile end user unit.

In the context of the present invention, it is at least initially not required to determine the exact location of a mobile end user unit. Rather, the relation of one or more cells of the cellular communications environment and the mobile end user unit on the one hand, and the geographical monitoring area on the other hand is determined. An important aspect of the invention is to not obtain any information like shape, size etc. of the one or more cells of the cellular communications environment, but to only determine the presence/absence of the mobile end user unit in the one or more cells of the cellular communications environment. Usually the mobile telecommunications standards (GSM, UMTS etc.) provide for a definite correspondence between an active mobile end user unit and a cell. That is, a mobile end user unit can only be active in one cell (defined by a base station where the mobile end user unit is registered). Nevertheless, a mobile end user unit may be able to communicate with more than one base station in order to determine in which cell it is to be registered.

One technique for defining the geographical monitoring area is by moving of the mobile end user unit in a geographical area at least partially corresponding to the geographical monitoring area. For example, it is possible, to move the mobile end user unit along a street that is desired to be monitored.

For mapping the geographical monitoring area to cells of the cellular communications environment it is possible to obtain information, for example from a provider or operator of the cellular communications environment, which characterizes geographical cell areas. Here, a geographical cell area refers to a geographical area covered by a cell of the cellular communications environment. Then, at least one of the geographical cell areas is selected in a manner that the selected cell(s) comprises the geographical monitoring area. In selecting geographical cell areas, it is preferred that no geographical cell areas are considered which do not comprise at least a part of the geographical monitoring area.

According to a preferred embodiment, all cells of the cellular communications environment not covering a geographical area at least partially including the geographical monitoring area are excluded from the mapping step.

Further, it is possible that the mapping of the geographical monitoring area to cells of the cellular communications environment can be performed by moving the mobile end user unit in a geographical area at least partially corresponding to the geographical monitoring area. While moving the mobile end user unit, cells of the cellular communications environment are determined in which the mobile end user unit is moved. The cells identified in this manner are now considered as cells to which the geographical monitoring area is mapped.

For determining cells wherein the mobile end user unit is moved, it is possible to employ data characterizing cell communication units of the cellular communications environment. If, for example, the cellular communications environment is a cellular telephone network, cell communication units will be radio base stations.

Such cell communication unit characterizing data can be used by the mobile end user unit, by at least one of the cell communication units and/or a mainframe system of the cellular communications environment for carrying out the mapping step.

In order to determine cells wherein the mobile end user unit is active, it is possible to utilize data obtained from the mobile end user unit. Preferably, such data is a unique identifier of the mobile end user unit. In case of a cellular telephone network, such data can be an international mobile station equipment identity code, an international mobile subscriber identity code and the like.

For determining cells in which the mobile end user unit is active, it is also possible, to obtain data from cell communication units which identify the same.

In general, two applications of the monitoring of the geographical monitoring area are possible, each alone or both in combination. Namely, one thereof is an application wherein the monitoring is used to determine whether the mobile end user unit is within the geographical monitoring area while the other application determines whether the mobile end user unit has left the geographical monitoring area.

Preferably, information characterizing a result of the monitoring step is provided, for example, to a party that has requested the monitoring of the geographical monitoring area. To provide such information, it is contemplated that the respective data/information would be communicated from the mobile end user unit. For example, if the mobile end user unit is a mobile telephone such information can be provided through a telephone call, an SMS, E-mail and the like initiated from the mobile end user unit. Further, it is possible that such monitoring result information is communicated by a cell communications unit, for example a radio base station of a cellular telephone network through a telephone call, an SMS, E-mail and the like.

Further, the present invention provides a geographical area monitoring unit for localization of a mobile end user unit in a cellular communications environment. The geographical area monitoring unit comprises a connection unit for connecting to the mobile end user unit, and a processing unit for determining or identifying at least one cell of the cellular communications environment wherein the mobile end user units is active and for comparing the at least one cell wherein the mobile end user unit is active (the at least one identified cell) with at least one cell of the cellular communications environment to which a geographical monitoring area is mapped wherein the geographical monitoring area is a geographical area to be monitored and comprised by at least one geographical cell area associated with the at least one cell to which the geographical monitoring area is mapped (the at least one mapped cell) and for monitoring the geographical monitoring area on the basis of a result of the comparison to localize the mobile end user unit.

Preferably, the geographical area monitoring unit comprises an area memory for storing information indicating the at least one mapped cell.

Further, the present invention provides a mobile end user unit for localization in a cellular communications environment. The mobile end user unit comprises a geographical area monitoring unit for determining or identifying at least one cell of the cellular communications environment wherein the mobile end user units is active and for comparing the at least one cell wherein the mobile end user unit is active (the at least one identified cell) with at least one cell of the cellular communications environment to which a geographical monitoring area is mapped wherein the geographical monitoring area is a geographical area to be monitored and comprised by at least one geographical cell area associated with the at least one cell to which the geographical monitoring area is mapped (the at least one mapped cell) and for monitoring the geographical monitoring area on the basis of a result of the comparison to localize the mobile end user unit.

Preferably, the mobile end user unit comprises an area memory for storing information indicating the at least one mapped cell.

Further, the present invention provides a cell communications unit for localization of a mobile end user unit in a cellular communications environment. The cell communications unit comprises a geographical area monitoring unit for identifying at least one cell of the cellular communications environment wherein the mobile end user units is active and for comparing the at least one cell wherein the mobile end user unit is active with (the at least one identified cell) at least one cell of the cellular communications environment to which a geographical monitoring area is mapped wherein the geographical monitoring area is a geographical area to be monitored and comprised by at least one geographical cell area associated with the at least one cell to which the geographical monitoring area is mapped (the at least one mapped cell) and for monitoring the geographical monitoring area on the basis of a result of the comparison to localize the mobile end user unit.

Preferably, the cell communications unit comprises an area memory for storing information indicating the at least one mapped cell.

In case of a telephone related application, the cell communications unit can be a radio base station for a cellular telephone network.

Further, the present invention provides a software program product which comprises software program code portions for carrying out the method steps according to the present invention.

Preferably, the software program product is stored on a computer readable storage medium or in a computer readable storage device. In some embodiments, the software product is utilized by a computer system for localization of a mobile end user unit comprising a processor and a memory coupled to the processor, where the memory encodes the software product and causes the processor to perform various steps.

Further, the present invention provides a service for localization of a mobile end user unit by monitoring a geographical area utilizing a cellular communications environment. The service comprises the steps of offering the service to a party which requests to monitor a geographical area in order to localize the mobile end user unit, mapping the geographical monitoring area to at least one cell of the cellular communications environment such that a geographical area corresponding to the at least one cell of the cellular communications environment comprises the geographical monitoring area, determining or identifying at least one cell of the cellular communications environment wherein the mobile end user unit is active, comparing the at least one cell wherein the mobile end user unit is active (the at least one mapped cell) and the at least one cell to which the geographical monitoring is mapped (the at least one mapped cell), and monitoring the geographical monitoring area on the basis of a result of the comparing step to localize of the mobile end user unit.

The following options and alternatives are contemplated for the service according to the present invention.

The definition or identification step can be performed on the basis of information provided by the party requesting the monitoring of the geographical area.

A result of the monitoring step can be provided to the party requesting the monitoring of the geographical area.

The service can be a service for a cellular telephone network or a service offered via the Internet.

The defining or identification step can comprise moving the mobile end user unit in a geographical area at least partially corresponding to the geographical monitoring area.

The mapping step can comprise obtaining information characterizing geographical cell areas, each geographical cell area being a geographical area corresponding to one of the cells of the cellular communications environment, and selecting at least one of the geographical cell areas such that the at least one selected geographical cell area comprises the geographical monitoring area.

Cells of the cellular communications environment having a geographical cell area outside the geographical monitoring area can be excluded from the mapping step

The mapping step can comprise moving the mobile end user unit in a geographical area at least partially corresponding to the geographical monitoring area, determining cells of the cellular communication environment in which the mobile end user unit is moved, and using the cells in which the mobile end user unit is moved as cells to which the geographical monitoring area is mapped.

The determination of the cells in which the mobile end user unit is moved can be based on data characterizing at least one cell communications unit of the cellular communications environment, wherein each cell communications unit characterizing data indicates a cell communications unit which is associated to a respective one of the cells of the cellular communications environment.

The cell communications unit characterizing data can be utilized by the mobile end user unit for carrying out the mapping step.

The cell communications unit characterizing data can be used by at least one of the at least one cell communications unit of the cellular communications environment and a mainframe system of the cellular communications environment for carrying out the mapping step.

The determination or identification of the at least one cell wherein the mobile end user unit is active can comprise obtaining mobile end user unit identifying data from the mobile end user unit, the mobile end user unit identifying date uniquely identifying the mobile end user unit.

The determination or identification of the at least one cell wherein the mobile end user unit is active can comprise obtaining cell communications unit identifying data from at least one of the cells of the cellular communications environment, the cell communications unit identifying data uniquely identifying a cell communication unit associated to a corresponding one of the cells of the cellular communications environment.

The monitoring of the geographical monitoring area can be used to determine whether the mobile end user unit is within the geographical monitoring area.

The monitoring of the geographical monitoring area can used to determine whether the mobile end user unit has left the geographical monitoring area.

The comparing step can comprise determining whether the at least one cell wherein the mobile end user unit is active corresponds with one of the at least one cell to which the geographical monitoring area is mapped.

The monitoring of the geographical monitoring area can indicate that the mobile end user unit is within the geographical monitoring area if the determination step indicates that one of the at least one identified cell corresponds with one of the at least one mapped cell.

The service can include providing of information indicating a result of the monitoring step.

The information indicating the result of the monitoring step can be communicated from the mobile end user unit.

The information indicating the result of the monitoring step can be communicated by a cell communications unit of the cellular communication environment, the cell communications unit providing communications in an associated one of the cells of the cellular communications environment.

Further, the geographical area monitoring unit according to the present invention can be adapted to be operated according to a method according to the present invention. Also, it is possible that the geographical area monitoring comprises a memory wherein a software program product according to the present invention is stored.

Moreover, the geographical area monitoring unit according to the present invention can be adapted to be used for at least one of a mobile end user unit according to the present invention, a cell communications unit according to the present invention, a cellular communications environment and a service according to the present invention.

Further, the mobile end user unit according to the present invention, wherein the geographical area monitoring unit is a geographical area monitoring unit according to the present invention. Also, the mobile end user unit can be adapted to be operated according to a method according to the present invention. Preferably, the mobile end user unit comprises a memory wherein a software program product according to the present invention is stored. Moreover, the mobile end user unit can be adapted to be used for at least one of the cell communications unit according to the present invention, a cellular communications environment and a service according to the present invention.

Further, the cell communications unit according to the present invention can be adapted to be operated according to a method according to the present invention. Also, the cell communications unit can comprise a memory wherein a software program product according to the present invention is stored. As an option, the cell communications unit can be adapted to be used for at least one of a cellular communications environment and a service according to the present invention.

Further, the present invention provides a cellular communications environment which comprises at least one of a geographical area monitoring unit according to the present invention in combination with a mobile end user unit, a mobile end user unit according to the present invention, a cellular communications unit according to the present invention and a software program product according to the present invention.

Preferably, the cellular communications environment is at least one of being adapted to be operated according to a method according to the present invention and being adapted for use for a service according to the present invention.

The cellular communications environment according to the present invention can be a cellular telephone network.

Other features and advantages of the present invention will become apparent from the following description of the exemplary embodiments, taken in conjunction with the accompanying drawings, which illustrate, by way of example, principles of the invention.

### BRIEF DESCRIPTION OF THE ACCOMPANYING FIGURES

In the following description of preferred embodiments is referred to the accompanying drawings wherein:

FIG. 1 shows an illustration of an external area monitoring unit according to the present invention;

FIGS. 2 to 4 show illustrations of the external area monitoring unit of FIG. 1 in combination with a mobile telephone;

FIG. 5 shows an illustration of a mobile end user unit according to the present invention;

FIG. 6 shows an illustration of a radio basis station implementing an area monitoring according to the present invention for a cellular communications environment;

FIG. 7 shows an illustration of a cellular communication environment implementing an area monitoring according to the present invention;

FIG. 8 shows an illustration of an area monitoring and a monitoring area definition, respectively, according to the present invention;

FIGS. 9 to 11 show illustrations of various applications the present invention; and

FIG. 12 is a flow chart illustrating a method of localization of a mobile unit in accordance with the invention.

### DESCRIPTION OF THE PREFERRED EMBODIMENTS

In the following, external units for mobile end user units, mobile end user units, cell communications units, cellular communications environments and methods according to the present invention for an area monitoring are described.

While the preferred embodiments of the present invention are described with respect to an implementation of a present invention in a cellular telephone network as an example for a cellular communications environment, one of ordinary skill in the art will realize that other embodiments may be implemented. Accordingly, mobile end user units will refer to mobile telephones and cell communications units will refer to radio base stations of the cellular telephone network.

External Geographical Area Monitoring Unit

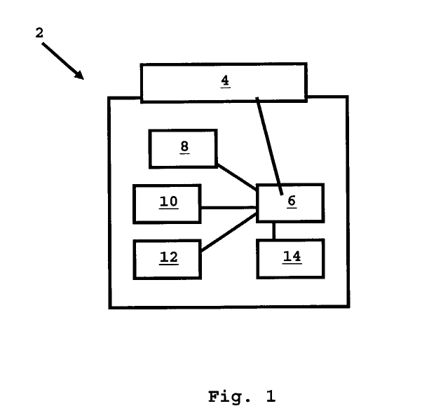

FIG. 1 illustrates an external geographical area monitoring unit 2 for use with a mobile telephone. In operation, the external geographical area monitoring 2 is in communication with a mobile telephone (not shown) by means of a connector 4. The connector 4 provides a line of communication between the external geographical area monitoring unit 2 and a mobile telephone via a communication port (not shown) of the mobile telephone. Examples for such a communication port of mobile telephones include socket connectors usually used for connecting to a head set, to an in-car telephone unit, a personal computer and the like. The type of connector 4 will vary in dependence from the type of mobile telephone used in connection with the external geographical area monitoring unit 2. For connection with different types of mobile telephones, adapters can be used to adapt the connector 4 to the type of socket connector of the mobile telephone to be used. In some embodiments, the connector 4 provides a wireless connection to the mobile telephone using a technology such as Bluetooth.

Via the connection provided by the connector 4, the external geographical area monitoring unit 2 receives information from a mobile telephone for carrying out a monitoring of a geographical area. Further, data/information relating to results of the geographical area monitoring executed by the external geographical area monitoring unit 2 are transmitted via the connector 4 to a mobile telephone.

The external geographical area monitoring unit 2 includes microprocessor or processing unit 6 which control the operations of the external geographical area monitoring unit 2. Operations software for the processing unit 6 can be stored therein or in an operation software memory 8. Data/information concerning a geographical area to be monitored by the external geographical area monitoring unit 2 is stored in an area memory 10. Further, if not provided by the processing unit 6, dialing means 12 can be integrated into the external geographical area monitoring unit 2 for initiating telephone calls by the mobile telephone connected to the external geographical area monitoring unit 2. In this arrangement, a power supply 14 is used to power the external area monitoring unit 2. In other arrangements, the external area monitoring unit 2 may be powered by a mobile telephone connected thereto via the pluck connector 4.

Data/information concerning a geographical area to be monitored can be stored in the area memory 10 by performing a monitoring area definition as described below. Data/information concerning a geographical area to be monitored can be pre-stored in the area memory 10 during manufacture or it can be provided when the external monitoring unit 2 is purchased depending on the geographical area desired to be monitored. Further, it is contemplated that data/information concerning a geographical area to be monitored is stored in the area memory 10 via connector 4 by a system or unit capable of transferring such data to the external area monitoring unit 2. Suitable systems and units include personal computers and respective software programs being adapted to transmit such data/information via a respective connector or interface to the external geographical area monitoring unit 2. In the latter case, it is preferred that such systems and units for providing geographical area data/information are programmable to allow for different data/information to be stored in the area memory 10 for a variety of different applications.

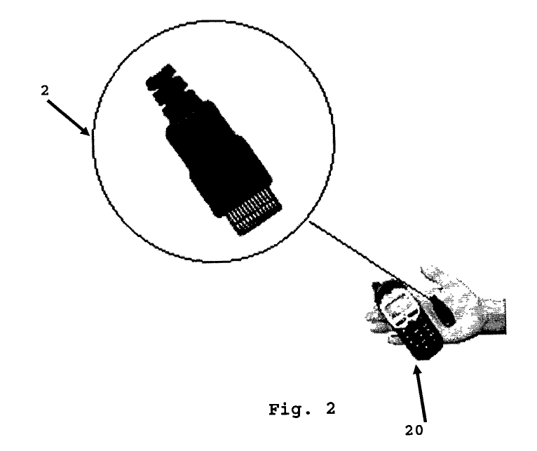

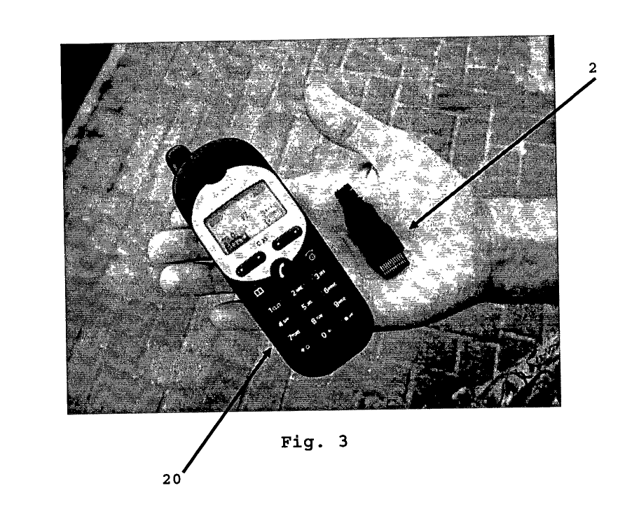

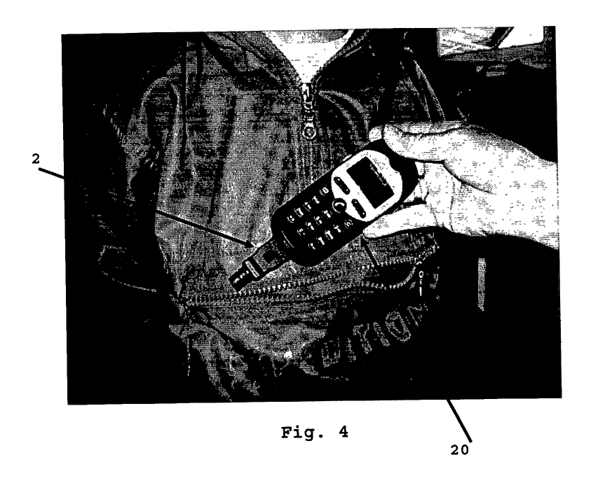

FIGS. 2 and 3 show a manufactured example of the external area monitoring unit 2 and a mobile telephone 20 to be used in combination therewith. FIG. 4 shows the exemplary external geographical area monitoring unit 2 and the mobile telephone 20 of FIGS. 2 and 3 in connection and for monitoring geographical locations of a child.

Mobile Telephone With Area Monitoring

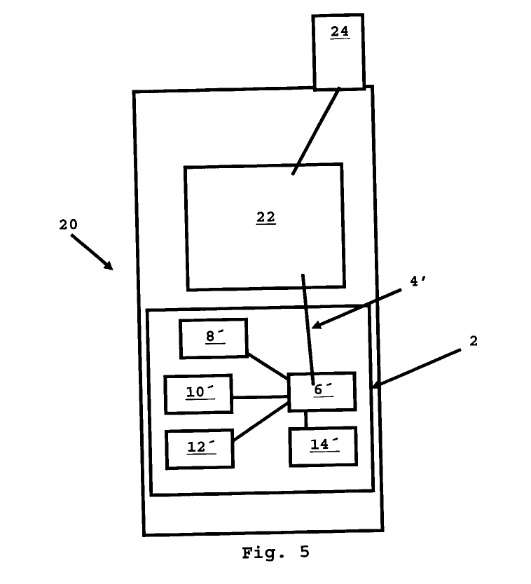

FIG. 5 illustrate a mobile telephone 20 which comprises components generally indicated at 22 for conventional telephone functions, an antenna 24 for signal communications in a respective telephone network and an intergrated internal geographical area monitoring unit 2′. The components 22 within the system for conventional telephone operations and functions are well known. Therefore, a description of details of the components 22 and its operations and functions are omitted.

The internal geographical area monitoring unit 2′ comprises a connection 4′ to the components 22, a microprocessor or processing unit 6′, and optionally, an operation software memory 8′ and an area memory 10′. Due to the integration of the internal geographical area monitoring unit 2 in the mobile telephone 20, it is assumed that power supply for the internal geographical area monitoring unit 2′ is provided by the mobile telephone. The same applies for the function of the dialing means 12 of FIG. 1. Therefore, the internal geographical area monitoring unit 2′ is shown without its own power supply and its own dialing means. Nevertheless, it is possible that the internal geographical area monitoring unit 2′ comprises such components comparable to the dialing means 12 and the power supply 14 of the external geographical area monitoring unit 2 illustrated in FIG. 1.

Data/information pertaining to a geographical area to be monitored can be transferred to the area memory 10′ by means of the components 22 received via the antenna 24 and/or received via a connector or interface (not shown) of the mobile telephone 20 for example from a personal computer (not shown). A transfer of geographical area data/information to the area memory 10′ is also possible via a connector or interface for the internal geographical area memory unit 2′. The latter option allows the use of a connector/interface for the internal area monitoring 2′ different than the connector/interface of the mobile telephone 20. This arrangement is advantageous when the mobile telephone connector/interface does not have an interface suitable for transferring geographical area data/information to the area memory 10′.

FIG. 5 illustrates the separation between the components 22 and the internal geographical area monitoring unit 2′. This arrangement is advantageous if a mobile telephone is to be equipped with geographical area monitoring capability without redesigning/modifying conventional its components 22. In this case, the integral geographical area monitoring unit 2′ is incorporated into the mobile telephone 20 and respectively connected to its components 22.

In contrast to the illustration of FIG. 5, the components 22 and the internal geographical area monitoring unit 2′ can be formed as an integral unit wherein, for example, a common processing unit (not shown) and common dialing means (not shown) are used for conventional telephone operations and functions and monitoring of a geographical area.

Radio Base Station With Area Monitoring

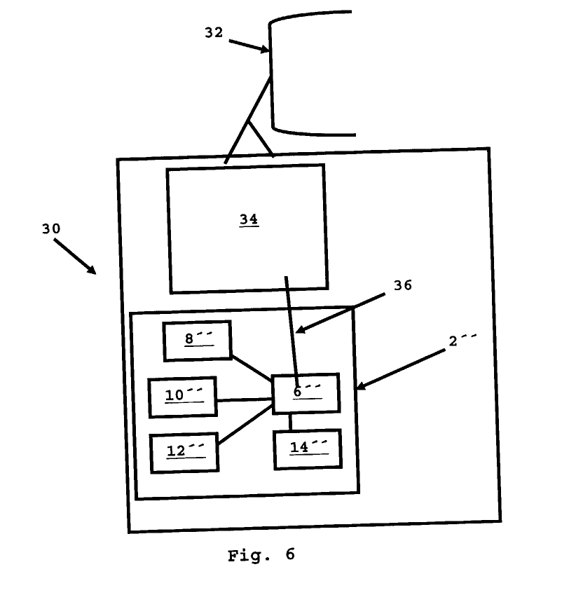

FIG. 6 illustrates a radio base station 30 servicing a cell of a cellular telephone network. For radio signal communication with a mobile telephone such as mobile telephone 20 shown in FIG. 5, the radio base station 30 comprises an antenna arrangement 32 and components 34 for conventional operations and functions such as sending and receiving signals to and from mobile telephones.

In case the mobile telephone 20 illustrated in FIG. 5 is used, the radio base station 30 can be used as a conventional radio base station since area monitoring capabilities are provided by the mobile telephone 20. In contrast, the radio base station 30 may provide for area monitoring capabilities. Such an arrangement comprises a geographical area monitoring unit 2″ including a processing unit 6″ and an operating software memory 8″ associated thereto. Via an interface unit 36, communications and data/information transfer between the components 34 and the processing unit 2″ are accomplished.

The radio base station 30 servicing a cell of its cellular telephone network can service a plurality of mobile telephones. Therefore, it is intended that the radio base station 30 is provided with area monitoring capabilities for a plurality of a different mobile telephones. Depending on the maximum number of mobile telephones which can be serviced by the radio base station 30 or a number of mobile telephones for which an area monitoring capability should be provided, the radio base station 30, particularly its geographical area monitoring unit 2″, comprises a corresponding number of area memories 10₁″, . . . , 10ₙ″. The area memories 10₁″, . . . , 10ₙ″ can be in the form of separate memory units or can be parts of a common memory unit to respectively store data/information concerning an area to be monitored for a specific mobile telephone. As a result, for different mobile telephones, different geographical areas for area monitoring may be defined.

As with the mobile telephone 20 illustrated in FIG. 5, an integrally incorporated arrangement of the components 34 and the geographical area monitoring unit 2″ is contemplated.

Data/information to be stored in respective area memories 10₁″, . . . , 10ₙ″ can be acquired by the radio base station 30 by itself as described below, can be transmitted from mobile telephones via the antenna arrangement 32 and/or can be provided by a mainframe system of the cellular telephone network of the radio base station 30 as described below.

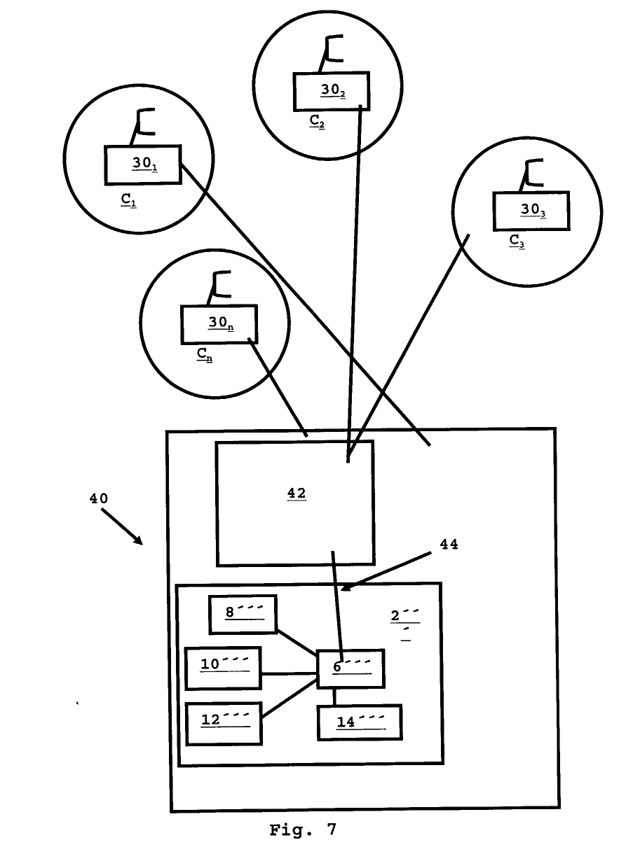

FIG. 7 illustrates a cellular telephone network comprising cells C₁, . . . , Cₙ each thereof serviced by a radio base station 30₁, . . . , 30ₙ. For controlling and operating the cellular telephone network, a mainframe system 40 is used. Examples for the mainframe system 40 include computer systems of a provider of the cellular telephone network and the like. Through a wired and/or wireless communications links (not indicated), the mainframe system 40 can communicate with the radio base stations 30₁, . . . , 30ₙ and vice versa.

The radio base stations 30₁, . . . , 30ₙ can be in the form of conventional radio base stations or of a type comparable to the radio base station 30 described with respect to FIG. 6. Beside, The mainframe system 40 comprises conventional components 42 for conventional operations and functions which are coupled to a geographical area monitoring unit 2′″ via connector/interface 44. The geographical area monitoring unit 2′″ comprises a processing unit 6′″ for operations and functions related to monitoring of geographical areas and an operation software memory 8′″ associated thereto for storing and providing software programs to the processing units 6′″. Comparable to the radio base station 30, for servicing a plurality of mobile telephones, the geographical area monitoring unit 2′″ includes a respective number of area memories 10₁′″, . . . , 10ₙ′″. The description given for the area memories of the radio base station 30 shown in FIG. 6 correspondingly applies to the area memories 10₁′″, . . . , 10ₙ′″ of geographical area monitoring unit 2′″.

Definition of a Geographical Area to be Monitored

Cells of a cellular communications environment are associated to geographical areas serviced by cell communications units, for example radio base stations in the case of a telephone network.

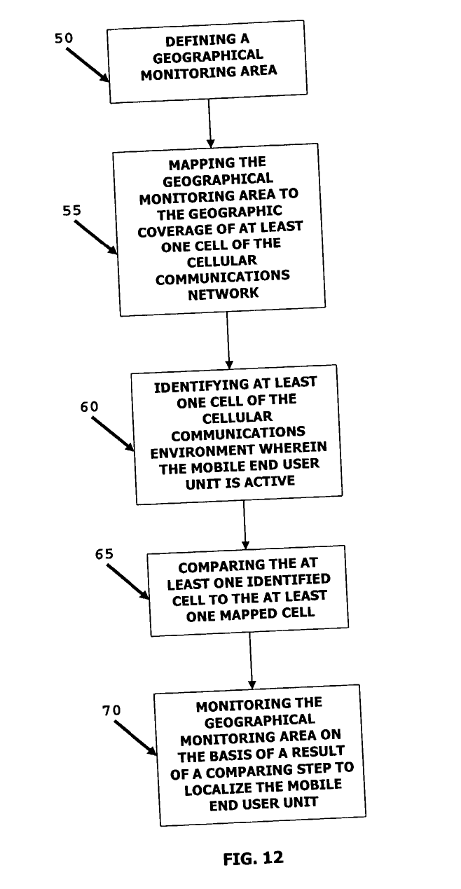

With reference to step 50 of FIG. 12, for defining a geographical area to be monitored, the geographical area to be monitored is mapped to cells of the telephone network such that the complete geographical area to be monitored is covered by one or more telephone network cells (see step 55). The correspondence between the geographical area to be monitored and an actual geographical area covered by telephone network cells depends on the cell sizes. As a result, a small cell size results in a higher correspondence between the geographical area to be monitored and a geographical area covered cells. Typically, cell sizes in a telephone network depend on the number of radio bases station. In particular, within urban environments, the number of radio base station is increasing, resulting in a corresponding reduction of the geographic coverage of any one cell to facilitate the use of radio base stations having lower transmission power. Thus, monitoring of geographical areas defined within urban environment will exhibit an increasing accuracy in the future. In rural areas, usually a smaller number of radio base stations is employed. However, this does not represent a problem because such geographical areas usually require a lower monitoring resolution. This is due to the fact that possibilities of movement in rural areas are much less than in an urban area, for example due to a smaller number of streets.

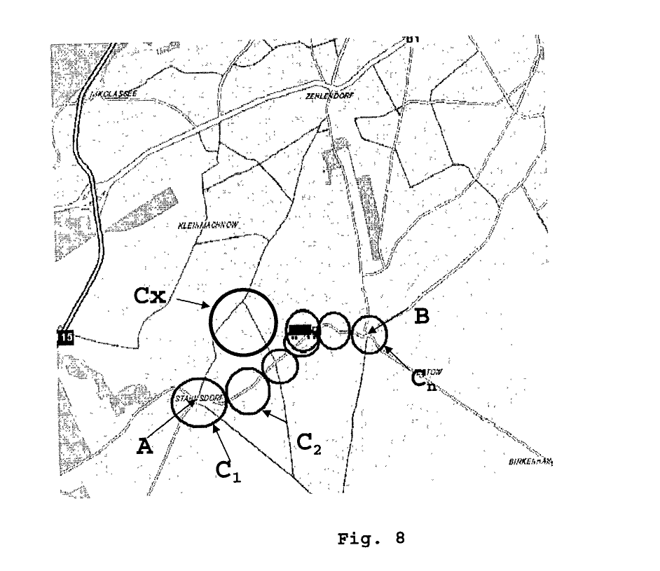

FIG. 8 illustrates a definition of a geographical area to be monitored on the basis of information concerning the cells of the telephone network. In this embodiment, the geographical area is monitored to determine whether a vehicle remains within that geographical area (see also steps 60, 65, 70, and 75 of FIG. 12). In the example illustrated in FIG. 8 a geographical area between location A and location B is monitored, in this case essentially corresponding with the street between locations A and B. The street between locations A and B, i.e. the geographical area to be monitored, is mapped to cells of the telephone network, here cells C₁, C₂, . . . , Cₙ.

For monitoring whether a monitored vehicle strays from the street between locations A and B is based on the position of the vehicle as compared to the cells C₁, . . . , Cₙ. If it is determined that the vehicle to be monitored is not within one of the cells C₁, . . . , Cₙ it can be assumed that it has left the street between locations A and B. If it is determined that the vehicle to be monitored is within at least one of the cells C₁, . . . , Cₙ can be assumed that the vehicle is still on the street between locations A and B. In the latter case, the determination of at least one of the cells C₁, . . . , Cₙ takes into account that cells of a cellular telephone network can overlap.

Monitoring of a geographical area can also detect when a person or moveable object enters into a pre-selected geographical area. For example, a geographical area can be defined into which a person or a moveable object should not enter. In the example shown in FIG. 8 it is assumed that a monitored vehicle should not enter location Cₓ. If it is determined that a vehicle to be monitored is within the cell Cₓ it can be assumed that the vehicle has entered the predefined forbidden geographical area i.e. location Cₓ. In cases where it is determined that a monitored vehicle is not within the cell Cₓ it can be assumed that no geographical area violation has occurred.

To determine whether a person or an object is within a predefined geographical area the invention determines whether a mobile telephone carried by a monitored person or object (e.g. vehicle) is serviced within at least one of the cells of the telephone network mapped to the geographical area monitored.

In case of a cellular telephone network, monitoring is accomplished by determining to which radio base station a mobile telephone to be monitored (corresponding to a person or an object to be monitored) is registered. This determination utilizes unique characterization data/information communicated from the monitored mobile telephone (e.g. an international mobile station equipment identity code, an international mobile subscriber identity code, a mobile station ISDN number and the like). Such data/information is received by radio base stations of the telephone network in cases where geographical monitoring is performed by radio base stations and/or a respective telephone network. In such a geographical area monitoring arrangement, radio base stations and telephone networks as illustrated in FIGS. 6 and 7 may be used with any conventional mobile telephone (i.e., mobile telephones that do not provide a geographical area monitoring function).

In cases where the geographical area monitoring is performed by a mobile telephone, a mobile telephone in combination with the external geographical area monitoring unit illustrated in FIG. 1 or a mobile telephone with geographical area monitoring as illustrated in FIG. 5 is used. Here, the external geographical area monitoring unit 2 or the internal geographical area monitoring unit 2′ obtains data/information from base stations which uniquely identify radio base stations. On the basis of such data/information it is determined whether received radio base station identifying data/information indicates cells to which a geographical area to be monitored is mapped. If this is the case, the mobile telephone is within the geographical area to be monitored. Data/information indicating that the mobile end user unit is not serviced by a radio base station of a cell to which no part of the geographical area to be monitored is mapped indicates that the mobile telephones is outside of the geographical area to be monitored.

If it is determined that a monitored person/object is outside the monitored geographical area, respective information (e.g. an alerting signal) is provided to a party which desires such information or has requested the geographical area monitoring. For example, it is possible to provide information to the parents of a monitored child so that they are constantly informed whether the monitored child remains within a predetermined geographical area or has left the same. A further example for such a receiving party is a technical person or a service system. In some instances, a response (the alert signal) to geographical area monitoring can be an emergency call to a police station or parents if the monitored person has left or entered a predefined geographical area.

Information (the alert signal) concerning results of geographical area monitoring may be provided in form of telephone calls, speech processing-based messages, SMS-massages, email-massages, facsimiles and the like.

Depending on whether a geographical area monitoring is performed on the side of a mobile telephone (see in FIGS. 1 and 2) or on the side of a radio base stations and/or a telephone network (see FIGS. 6 and 7), the transmission of information regarding geographical area monitoring is initiated by a mobile telephone or a radio base station and/or its telephone network.

Geographical area monitoring performed on the side of radio base station and/or a telephone network will be generally provided by a respective network operator or provider. Geographical area monitoring performed on the side of mobile telephones require the use of an external geographical monitoring unit 2 as illustrated in FIG. 1 or a mobile telephone 20 with an external geographical area monitoring unit 2 as illustrated in FIGS. 2-3. Such geographical monitoring can be performed independently from a telephone network operator or provider as all geographical area monitoring operations and functions are carried out on the user's side.

Teach-In Definition of a Geographical Area to be Monitored

In the previously described definition of a geographical area to be monitored, information concerning the geographical arrangement and coverage of cells of the telephone network are required. An improved and more user-friendly definition of a geographical area to be monitored can be obtained by a “teach-in” definition of a geographical area to be monitored as described below.

Again referring to FIG. 8 it is assumed that the street between locations A and B should be monitored. For a teach-in definition of this geographical area, a mobile telephone is moved from location A via that street to location B.

During that movement, the cells C₁, . . . , Cₙ through which the mobile telephone is moved are registered. As a result, the street as the geographical area to be monitored is mapped to respective cells of the telephone network. On the basis of the obtained cells C₁, . . . , Cₙ a geographical area monitoring of the street between locations A and B is possible.

In case geographical area monitoring is to be performed on the side of radio base stations and/or its telephone network, the teach-in definition of a geographical area to be monitored is executed on the basis of data/information identifying a mobile telephone received from radio base stations of cells covering the geographical area to be monitored. The received data/information identifying the mobile telephone in combination with information identifying the receiving radio base stations provide for a mapping of the geographical area to be monitored to corresponding network cells.

In case geographical area monitoring is to be performed on the side of a mobile telephone, the teach-in definition of a geographical area to be monitored is based on date/information that identifies radio base stations in communication with a mobile telephone during a teach-in procedure. The receiving radio base station identifying data/information is stored by the external geographical area monitoring unit 2 or the internal monitoring unit 2′ (see FIGS. 1 and 2) and used for carrying out an associated geographical area monitoring.

Geographical Area Monitoring Using a Mobile End User Unit

When it is desirable to carry out geographical area monitoring on the side of a mobile end user unit such as a mobile telephone, the mobile end user unit does not need to be operated for actual communications such as a telephone call in case of a mobile telephone. Rather, it is sufficient that a mobile end user is turned on such that fundamental signaling is carried out. Examples for such a fundamental signaling in a telephone network include communications of data/information identifying mobile telephones, data/information used for hand over procedures between different cells of a telephone network and the like.

Geographical Area Monitoring Using a Cell Communication Unit and/or a Cellular Communication Environment

Geographical area monitoring on the side of cell communication units and/or a cellular communications environment (for example radio base stations and/or its telephone network) does not require that the end user units to be monitored are actually operated for communication purposes. Rather, the above fundamental signaling is sufficient.

For situations where it is desirable to monitor whether an end user unit is within cells corresponding to geographical area to be monitored, respective data/information can be obtained continuously or in predefined time intervals. In order to reduce the load of cell communications units and/or a communications environment it is possible to obtain data/information necessary for a geographical area monitoring only when a mobile end user unit to be monitored leaves a cell and enters a new cell, i.e. for hand over procedures.

Applications

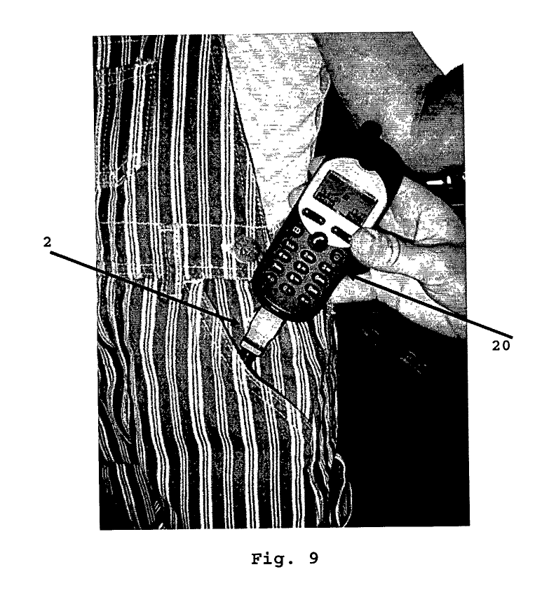

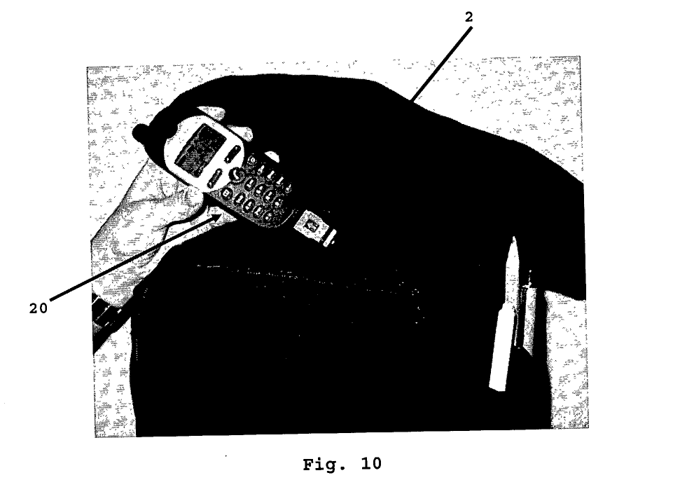

Examples for geographical area monitoring include monitoring a child on its way to school to verify that the child does not stray from a desired route. For geographical area monitoring for the child, the child is equipped with a mobile end user unit, for example a mobile telephone. The telephone can have geographical area monitoring functionality independent on which side a geographical area monitoring will be performed. For equipping a person for example a child, an end user unit can be just put into the pocket of the jacket (See FIG. 9), school bag (see FIG. 10) or can be integrated in a toy, for example a teddy bear.

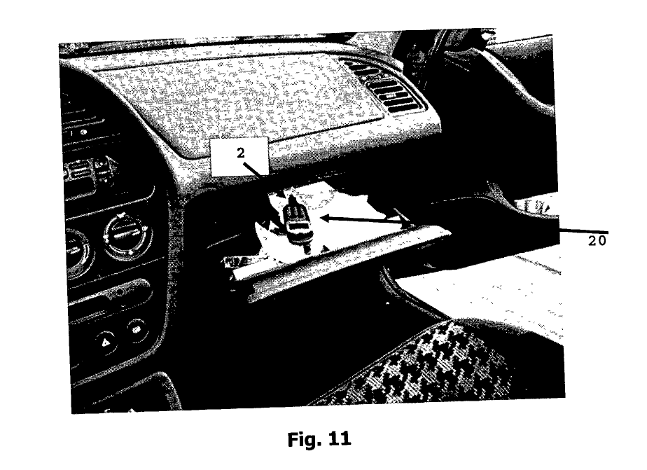

For monitoring movable objects such as vehicles, a mobile end user unit is associated to a movable object to be monitored. This can be accomplished by integrally incorporating a mobile telephone in the respective object or, for example, by simply putting a mobile telephone into a car (see FIG. 11).

It will, of course, be understood that modifications to the exemplary embodiments will be apparent to those skilled in the art. Consequently, the scope of the present invention should not be limited by the particular embodiments discussed above, but should be defined only by the claims set forth below and equivalents thereof.

What is claimed is:

1. A method for localization of a mobile end user unit by monitoring a geographical area utilizing a cellular communications environment, the method comprising the steps of:
defining a geographical monitoring area, the geographical monitoring area being a geographical area to be monitored;
mapping the geographical monitoring area to at least one cell of the cellular communications environment such that a geographical area corresponding to the at least one cell of the cellular communications environment comprises the geographical monitoring area;
identifying at least one cell of the cellular communications environment wherein the mobile end user unit is active;
comparing the at least one identified cell and the at least one mapped cell; and
monitoring the geographical monitoring area on the basis of a result of a comparing step to localize the mobile end user unit.

2. The method of claim 1, wherein the defining step comprises:
moving the mobile end user unit in a geographical area at least partially corresponding to the geographical monitoring area.

3. The method of claim 1, wherein the mapping step comprises:
obtaining information characterizing geographical cell areas, each geographical cell area being a geographical area corresponding to one of the cells of the cellular communications environment; and
selecting at least one of the geographical cell areas such that the at least one selected geographical cell area comprises the geographical monitoring area.

4. The method of claim 1, wherein cells of the cellular communications environment having a geographical cell area outside the geographical monitoring area are excluded from the mapping step.

5. The method of claim 1, wherein the mapping step comprises:
moving the mobile end user unit in a geographical area at least partially corresponding to the geographical monitoring area;
determining cells of the cellular communication environment in which the mobile end user unit is moved; and
using the cells in which the mobile end user unit is moved as cells to which the geographical monitoring area is mapped.

6. The method of claim 5, wherein the identification of the cells in which the mobile end user unit is moved is based on data characterizing at least one cell communications unit of the cellular communications environment, wherein each cell communications unit characterizing data indicates a cell communications unit which is associated to a respective one of the cells of the cellular communications environment.

7. The method of claim 6, wherein the cell communications unit characterizing data is utilized by the mobile end user unit for carrying out the mapping step.

8. The method of claim 6, wherein the cell communications unit characterizing data is used by at least one of the at least one cell communications unit of the cellular communications environment and a mainframe system of the cellular communications environment for carrying out the mapping step.

9. The method of claim 1, wherein the identification of the at least one identified cell comprises:
obtaining mobile end user unit unique identification data from the mobile end user unit.

10. The method of claim 1, wherein the identification of the at least one identified cell comprises:
obtaining cell communications unit identifying data from at least one of the cells of the cellular communications environment, the cell communications unit identifying data uniquely identifying a cell communication unit associated to a corresponding one of the cells of the cellular communications environment.

11. The method of claim 1, wherein the monitoring of the geographical monitoring area is used to determine whether the mobile end user unit is within the geographical monitoring area.

12. The method of claim 1, wherein the monitoring of the geographical monitoring area is used to determine whether the mobile end user unit has left the geographical monitoring area.

13. The method of claim 1, wherein the comparison step comprises:
determining whether the at least one identified cell corresponds with one of the at least one mapped cell.

14. The method of claim 13, wherein the monitoring of the geographical monitoring area indicates that the mobile end user unit is within the geographical monitoring area if the determination indicates that one of the at least one identified cell corresponds with one of the at least one mapped cell.

15. The method of claim 1, further comprising the step of providing information indicating a result of the monitoring step.

16. The method of claim 15, wherein the information indicating the result of the monitoring step is communicated from the mobile end user unit.

17. The method of claim 15, wherein the information indicating the result of the monitoring step is communicated by a cell communications unit of the cellular communication environment, the cell communications unit providing communications in a respective one of the cells cellular communications environment.

19. The method of claim 1, wherein the mobile end user unit is a mobile telephone and the cellular communications environment is a cellular telephone network using radio base stations as cell communications units for its network cells.

20. A geographical area monitoring unit for localization of a mobile end user unit in a cellular communications environment, the geographical area monitoring unit comprising:
a connection unit for connecting to the mobile end user unit; and
a processing unit for identifying at least one cell of the cellular communications environment wherein the mobile end user units is active and for comparing the at least one identified cell with at least one cell of the cellular communications environment to which a geographical monitoring area is mapped wherein the geographical monitoring area is a geographical area to be monitored and comprised by at least one geographical cell area associated with the at least one mapped cell and for monitoring the geographical monitoring area on the basis of a result of the comparison to localize the mobile end user unit.

21. The geographical area monitoring unit of claim 20, comprising:
an area memory for storing information indicating the at least one mapped cell.

22. A mobile end user unit for localization in a cellular communications environment, the mobile end user unit comprising:
a geographical area monitoring unit for identifying at least one cell of the cellular communications environment wherein the mobile end user units is active and for comparing the at least one identified cell with at least one cell of the cellular communications environment to which a geographical monitoring area is mapped, wherein the geographical monitoring area is a geographical area to be monitored and comprised by at least one geographical cell area associated with the at least one mapped cell and for monitoring the geographical monitoring area on the basis of a result of the comparison to localize the mobile end user unit.

23. The mobile end user unit of claim 22, comprising:
an area memory for storing information indicating the at least one mapped cell.

24. A cell communications unit for localization of a mobile end user unit in a cellular communication environment, the cell communications unit comprising:
a geographical area monitoring unit for identifying at least one cell of the cellular communications environment wherein the mobile end user units is active and for comparing the at least one identified cell with at least one cell of the cellular communications environment to which a geographical monitoring area is mapped wherein the geographical monitoring area is a geographical area to be monitored and comprised by at least one geographical cell area associated with the at least one mapped cell and for monitoring the geographical monitoring area on the basis of a result of the comparison to localize the mobile end user unit.

25. The cell communications unit of claim 24, comprising:
an area memory for storing information indicating the at least one mapped cell.

26. The cell communications unit of claim 24, wherein the cell communications unit is a radio base station for a cellular telephone network.

27. A software program product, comprising:
software program code portions for carrying out the steps of:
defining a geographical monitoring area, the geographical monitoring area being a geographical area to be monitored;
mapping the geographical monitoring area to at least one cell of the cellular communications environment such that a geographical area corresponding to the at least one cell of the cellular communications environment comprises the geographical monitoring area;
identifying at least one cell of the cellular communications environment wherein the mobile end user unit is active;
comparing the at least one identified cell to the at least one mapped cell; and
monitoring the geographical monitoring area on the basis of a result of a comparing step to localize the mobile end user unit.

28. The software program product of claim 27, wherein the software program product is stored on a computer readable storage medium or in a computer readable storage device.

29. A service for localization of a mobile end user unit by monitoring a geographical area utilizing a cellular communications environment, the service comprising the steps of:
offering the service to a party which requests monitoring of a geographical area in order to localize the mobile end user unit;
mapping the geographical monitoring area to at least one cell of the cellular communications environment such that a geographical area corresponding to the at least one cell of the cellular communications environment comprises the geographical monitoring area;
identifying at least one cell of the cellular communications environment wherein the mobile end user unit is active;
comparing the at least one identified cell and the at least one mapped cell; and
monitoring the geographical monitoring area on the basis of a result of the comparing step to localize of the mobile end user unit.

30. The service of claim 29, wherein the defining step is performed on the basis of information provided by the party requesting the monitoring of the geographical area.

31. The service of claim 29, wherein a result of the monitoring step is provided to the party requesting the monitoring of the geographical area.

32. The service of claim 29, being a service provided in connection with a cellular telephone network.

33. The service of claim 29, wherein the service is offered via the Internet.

34. The service of claim 29, wherein the defining step comprises:
moving the mobile end user unit in a geographical area at least partially corresponding to the geographical monitoring area.

35. The service of claim 29, wherein the mapping step comprises:
obtaining information characterizing geographical cell areas, each geographical cell area being a geographical area corresponding to one of the cells of the cellular communications environment; and
selecting at least one of the geographical cell areas such that the at least one selected geographical cell area comprises the geographical monitoring area.

36. The service of claim 35, wherein cells of the cellular communications environment having a geographical cell area outside the geographical monitoring area are excluded from the mapping step.

37. The service of claim 29, wherein the mapping step comprises:
moving the mobile end user unit in a geographical area at least partially corresponding to the geographical monitoring area;
determining cells of the cellular communication environment in which the mobile end user unit is moved; and
using the cells in which the mobile end user unit is moved as cells to which the geographical monitoring area is mapped.

38. The service of claim 37, wherein the determination of the cells in which the mobile end user unit is moved is based on data characterizing at least one cell communications unit of the cellular communications environment, wherein each cell communications unit characterizing data indicates a cell communications unit which is associated to a respective one of the cells of the cellular communications environment.

39. The service of claim 38, wherein the cell communications unit characterizing data is utilized by the mobile end user unit for carrying out the mapping step.

40. The service of claim 38, wherein the cell communications unit characterizing data is used by at least one of the at least one cell communications unit of the cellular communications environment and a main frame system of the cellular communications environment for carrying out the mapping step.

41. The service of claim 29, wherein the identification of the at least one identified cell comprises:
obtaining mobile end user unit unique identification data from the mobile end user unit.

42. The service of claim 29, wherein the identification of the at least one identified cell comprises:
obtaining cell communications unit identifying data from at least one of the cells of the cellular communications environment, the cell communications unit identifying data uniquely identifying a cell communication unit associated to a corresponding one of the cells of the cellular communications environment.

43. The service of claim 29, wherein the monitoring of the geographical monitoring area is used to determine whether the mobile end user unit is within the geographical monitoring area.

44. The service of claim 29, wherein the monitoring of the geographical monitoring area is used to determine whether the mobile end user unit has left the geographical monitoring area.

45. The service of claim 29, wherein the comparison step comprises:
determining whether the at least one identified cell corresponds with one of the at least one mapped cell.

46. The service of claim 45, wherein the monitoring of the geographical monitoring area indicates that the mobile end user unit is within the geographical monitoring area if the determination indicates that one of the at least one identified cell corresponds with one of the at least one mapped cell.

47. The service of claim 29, comprising:
providing information indicating a result of the monitoring step.

48. The service of claim 47, wherein the information indicating the result of the monitoring step is communicated from the mobile end user unit.

49. The service of claim 47, wherein the information indicating the result of the monitoring step is communicated by a cell communications unit of the cellular communication environment, the cell communications unit providing communications in an associated one of the cells of the cellular communications environment.

51. The geographical area monitoring unit of claim 20, wherein the processing unit is adapted to be operated according to the steps of:
defining a geographical monitoring area, the geographical monitoring area being a geographical area to be monitored;
mapping the geographical monitoring area to at least one cell of the cellular communications environment such that a geographical area corresponding to the at least one cell of the cellular communications environment comprises the geographical monitoring area;
identifying at least one cell of the cellular communications environment wherein the mobile end user unit is active;
comparing the at least one identified cell to the at least one mapped cell; and
monitoring the geographical monitoring area on the basis of a result of a comparing step to localize the mobile end user unit.

52. The geographical area monitoring unit of claim 20, comprising:
a memory wherein a software program product, comprising software program code portions for carrying out the steps of defining a geographical monitoring area, the geographical monitoring area being a geographical area to be monitored; mapping the geographical monitoring area to at least one cell of the cellular communications environment such that a geographical area corresponding to the at least one cell of the cellular communications environment comprises the geographical monitoring area; identifying at least one cell of the cellular communications environment wherein the mobile end user unit is active; comparing the at least one identified cell to the at least one mapped cell; and monitoring the geographical monitoring area on the basis of a result of a comparing step to localize the mobile end user unit, is stored.

53. The geographical area monitoring unit of claim 20, being adapted to be used for at least one of the group comprised of:
a mobile end user unit for localization in a cellular communications environment, the mobile end user unit comprising a geographical area monitoring unit for identifying at least one cell of the cellular communications environment wherein the mobile end user units is active and for comparing the at least one identified cell with at least one cell of the cellular communications environment to which a geographical monitoring area is mapped, wherein the geographical monitoring area is a geographical area to be monitored and comprised by at least one geographical cell area associated with the at least one mapped cell and for monitoring the geographical monitoring area on the basis of a result of the comparison to localize the mobile end user unit;
a cell communications unit for localization of a mobile end user unit in a cellular communication environment, the cell communications unit comprising a geographical area monitoring unit for identifying at least one cell of the cellular communications environment wherein the mobile end user units is active and for comparing the at least one identified cell with at least one cell of the cellular communications environment to which a geographical monitoring area is mapped wherein the geographical monitoring area is a geographical area to be monitored and comprised by at least one geographical cell area associated with the at least one mapped cell and for monitoring the geographical monitoring area on the basis of a result of the comparison to localize the mobile end user unit;
a cellular communications environment; and
a service comprising the steps of offering the service to a party which requests monitoring of a geographical area in order to localize the mobile end user unit; mapping the geographical monitoring area to at least one cell of the cellular communications environment such that a geographical area corresponding to the at least one cell of the cellular communications environment comprises the geographical monitoring area; identifying at least one cell of the cellular communications environment wherein the mobile end user unit is active; comparing the at least one identified cell and the at least one mapped cell; and monitoring the geographical monitoring area on the basis of a result of the comparing step to localize of the mobile end user unit.

54. The mobile end user unit of claim 22, wherein the geographical area monitoring unit comprises:
a connection unit for connecting to the mobile end user unit; and
a processing unit for identifying at least one cell of the cellular communications environment wherein the mobile end user units is active and for comparing the at least one identified cell with at least one cell of the cellular communications environment to which a geographical monitoring area is mapped wherein the geographical monitoring area is a geographical area to be monitored and comprised by at least one geographical cell area associated with the at least one mapped cell and for monitoring the geographical monitoring area on the basis of a result of the comparison to localize the mobile end user unit.

55. The mobile end user unit of claim 22, being adapted to be operated according to the steps of:
defining a geographical monitoring area, the geographical monitoring area being a geographical area to be monitored;
mapping the geographical monitoring area to at least one cell of the cellular communications environment such that a geographical area corresponding to the at least one cell of the cellular communications environment comprises the geographical monitoring area;
identifying at least one cell of the cellular communications environment wherein the mobile end user unit is active;
comparing the at least one identified cell to the at least one mapped cell; and
monitoring the geographical monitoring area on the basis of a result of a comparing step to localize the mobile end user unit.

56. The mobile end user unit of claim 22, comprising:
a memory wherein a software program product, comprising software program code portions for carrying out the steps of defining a geographical monitoring area, the geographical monitoring area being a geographical area to be monitored; mapping the geographical monitoring area to at least one cell of the cellular communications environment such that a geographical area corresponding to the at least one cell of the cellular communications environment comprises the geographical monitoring area; identifying at least one cell of the cellular communications environment wherein the mobile end user unit is active; comparing the at least one identified cell to the at least one mapped cell; and monitoring the geographical monitoring area on the basis of a result of a comparing step to localize the mobile end user unit, is stored.

57. The mobile end user unit of claim 22, being adapted to be used for at least one of the group comprised of:
a cell communications unit for localization of a mobile end user unit in a cellular communication environment, the cell communications unit comprising:
a geographical area monitoring unit for identifying at least one cell of the cellular communications environment wherein the mobile end user units is active and for comparing the at least one identified cell with at least one cell of the cellular communications environment to which a geographical monitoring area is mapped wherein the geographical monitoring area is a geographical area to be monitored and comprised by at least one geographical cell area associated with the at least one mapped cell and for monitoring the geographical monitoring area on the basis of a result of the comparison to localize the mobile end user unit;
a cellular communications environment; and
the service comprising the steps of offering the service to a party which requests monitoring of a geographical area in order to localize the mobile end user unit; mapping the geographical monitoring area to at least one cell of the cellular communications environment such that a geographical area corresponding to the at least one cell of the cellular communications environment comprises the geographical monitoring area; identifying at least one cell of the cellular communications environment wherein the mobile end user unit is active; comparing the at least one identified cell and the at least one mapped cell; and monitoring the geographical monitoring area on the basis of a result of the comparing step to localize of the mobile end user unit.

58. The cell communications unit of claim 24, being adapted to be operated according to the steps of:
defining a geographical monitoring area, the geographical monitoring area being a geographical area to be monitored;
mapping the geographical monitoring area to at least one cell of the cellular communications environment such that a geographical area corresponding to the at least one cell of the cellular communications environment comprises the geographical monitoring area;
identifying at least one cell of the cellular communications environment wherein the mobile end user unit is active;
comparing the at least one identified cell to the at least one mapped cell; and
monitoring the geographical monitoring area on the basis of a result of a comparing step to localize the mobile end user unit.

59. The cell communications unit of claim 24, comprising:
a memory wherein a software program product, comprising software program code portions for carrying out the steps of defining a geographical monitoring area, the geographical monitoring area being a geographical area to be monitored; mapping the geographical monitoring area to at least one cell of the cellular communications environment such that a geographical area corresponding to the at least one cell of the cellular communications environment comprises the geographical monitoring area; identifying at least one cell of the cellular communications environment wherein the mobile end user unit is active; comparing the at least one identified cell to the at least one mapped cell; and monitoring the geographical monitoring area on the basis of a result of a comparing step to localize the mobile end user unit, is stored.

60. The cell communications unit of claim 24, being adapted to be used for at least one of the group comprised of:
a cellular communications environment; and
a service comprising the steps of offering the service to a party which requests monitoring of a geographical area in order to localize the mobile end user unit; mapping the geographical monitoring area to at least one cell of the cellular communications environment such that a geographical area corresponding to the at least one cell of the cellular communications environment comprises the geographical monitoring area; identifying at least one cell of the cellular communications environment wherein the mobile end user unit is active; comparing the at least one identified cell and the at least one mapped cell; and monitoring the geographical monitoring area on the basis of a result of the comparing step to localize of the mobile end user unit.

61. A cellular communications environment, comprising at least one of the group comprised of:
a geographical area monitoring unit for localization of a mobile end user unit in a cellular communications environment, the geographical area monitoring unit comprising a connection unit for connecting to the mobile end user unit, and a processing unit for identifying at least one cell of the cellular communications environment wherein the mobile end user units is active and for comparing the at least one identified cell with at least one cell of the cellular communications environment to which a geographical monitoring area is mapped wherein the geographical monitoring area is a geographical area to be monitored and comprised by at least one geographical cell area associated with the at least one mapped cell and for monitoring the geographical monitoring area on the basis of a result of the comparison to localize the mobile end user unit, wherein the geographical monitoring unit is used in combination with a mobile end user unit;
a mobile end user unit for localization in a cellular communications environment, the mobile end user unit comprising a geographical area monitoring unit for identifying at least one cell of the cellular communications environment wherein the mobile end user units is active and for comparing the at least one identified cell with at least one cell of the cellular communications environment to which a geographical monitoring area is mapped, wherein the geographical monitoring area is a geographical area to be monitored and comprised by at least one geographical cell area associated with the at least one mapped cell and for monitoring the geographical monitoring area on the basis of a result of the comparison to localize the mobile end user unit;
a cell communications unit for localization of a mobile end user unit in a cellular communication environment, the cell communications unit comprising a geographical area monitoring unit for identifying at least one cell of the cellular communications environment wherein the mobile end user units is active and for comparing the at least one identified cell with at least one cell of the cellular communications environment to which a geographical monitoring area is mapped wherein the geographical monitoring area is a geographical area to be monitored and comprised by at least one geographical cell area associated with the at least one mapped cell and for monitoring the geographical monitoring area on the basis of a result of the comparison to localize the mobile end user unit; and
a software program product, comprising software program code portions for carrying out the steps of defining a geographical monitoring area, the geographical monitoring area being a geographical area to be monitored; mapping the geographical monitoring area to at least one cell of the cellular communications environment such that a geographical area corresponding to the at least one cell of the cellular communications environment comprises the geographical monitoring area; identifying at least one cell of the cellular communications environment wherein the mobile end user unit is active; comparing the at least one identified cell to the at least one mapped cell; and monitoring the geographical monitoring area on the basis of a result of a comparing step to localize the mobile end user unit.

62. A cellular communications environment, being adapted to be operated according to the steps of:
defining a geographical monitoring area, the geographical monitoring area being a geographical area to be monitored;
mapping the geographical monitoring area to at least one cell of the cellular communications environment such that a geographical area corresponding to the at least one cell of the cellular communications environment comprises the geographical monitoring area;
identifying at least one cell of the cellular communications environment wherein the mobile end user unit is active;
comparing the at least one identified cell to the at least one mapped cell; and
monitoring the geographical monitoring area on the basis of a result of a comparing step to localize the mobile end user unit.

63. A cellular communications environment, being adapted for use for the service comprising the steps of:
offering the service to a party which requests monitoring of a geographical area in order to localize the mobile end user unit;
mapping the geographical monitoring area to at least one cell of the cellular communications environment such that a geographical area corresponding to the at least one cell of the cellular communications environment comprises the geographical monitoring area;
identifying at least one cell of the cellular communications environment wherein the mobile end user unit is active;
comparing the at least one identified cell and the at least one mapped cell; and
monitoring the geographical monitoring area on the basis of a result of the comparing step to localize of the mobile end user unit.

64. The cellular communications environment of claim 61, wherein the cellular communications network environment is a cellular telephone network.

65. The cellular communications environment of claim 62, wherein the cellular communications network environment is a cellular telephone network.

66. The cellular communications environment of claim 63, wherein the cellular communications network environment is a cellular telephone network

67. A system for localization of a mobile end user unit comprising
definition means for defining a geographical monitoring area, the geographical monitoring area being a geographical area to be monitored;
mapping means for mapping the geographical monitoring area to at least one cell of the cellular communications environment such that a geographical area corresponding to the at least one cell of the cellular communications environment comprises the geographical monitoring area;
identification means for identifying at least one cell of the cellular communications environment wherein the mobile end user unit is active;
comparison means for comparing the at least one identified cell to the at least one mapped cell; and
monitoring means for monitoring the geographical monitoring area on the basis of a result of a comparing step to localize the mobile end user unit.

68. A computer system for localization of a mobile end user unit comprising a processor and a memory coupled to the processor, the memory encoding one or more programs, the one or more programs causing the processor to perform a method comprising:
defining a geographical monitoring area, the geographical monitoring area being a geographical area to be monitored;
mapping the geographical monitoring area to at least one cell of the cellular communications environment such that a geographical area corresponding to the at least one cell of the cellular communications environment comprises the geographical monitoring area;
identifying at least one cell of the cellular communications environment wherein the mobile end user unit is active;
comparing the at least one identified cell to the at least one mapped cell; and
monitoring the geographical monitoring area on the basis of a result of a comparing step to localize the mobile end user unit.
